(19) United States
(12) Patent Application Publication
(10) Pub. No.: US 2023/0090025 A1
(43) Pub. Date: Mar. 23, 2023

(54) METHODS AND SYSTEMS FOR PERFORMING COMBINED INTER AND INTRA PREDICTION

(71) Applicant: Alibaba Singapore Holding Private Limited, Singapore (SG)

(72) Inventors: Ru-Ling LIAO, Beijing (CN); Jie CHEN, Beijing (CN); Xinwei LI, Beijing (CN); Yan YE, San Diego, CA (US)

(21) Appl. No.: 17/931,676

(22) Filed: Sep. 13, 2022

Related U.S. Application Data
(60) Provisional application No. 63/247,078, filed on Sep. 22, 2021.

(51) Int. Cl. H04N 19/107; H04N 19/186

(52) U.S. Cl. CPC H04N 19/107; H04N 19/186

(57) ABSTRACT

A method for video processing, wherein a combined inter and intra prediction (CIIP) and luma mapping with chroma scaling (LMCS) are applied. The method includes obtaining an inter prediction signal, an intra prediction signal, and an overlapped block motion compensation (OBMC) prediction signal; obtaining an intermediate weighted prediction signal by weighting the inter prediction signal and a first prediction signal of the intra prediction signal and the OBMC prediction signal; and obtaining a final prediction signal by weighting the intermediate weighted prediction signal and a second prediction signal of intra prediction signal and the OBMC prediction signal; wherein the intermediate weighted prediction signal and the second prediction signal are both in one of a mapped domain or an original domain.

### CROSS-REFERENCE TO RELATED APPLICATIONS

The disclosure claims the benefits of priority to U.S. Provisional Application No. 63/247,078, filed on Sep. 22, 2021, which is incorporated herein by reference in its entirety.

### TECHNICAL FIELD

The present disclosure generally relates to video processing, and more particularly, to methods and systems for performing combined inter and intra prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for video processing, wherein a combined inter and intra prediction (CIIP) and luma mapping with chroma scaling (LMCS) are applied. The method includes: obtaining an inter prediction signal, an intra prediction signal, and an overlapped block motion compensation (OBMC) prediction signal; obtaining an intermediate weighted prediction signal by weighting the inter prediction signal and a first prediction signal of the intra prediction signal and the OBMC prediction signal; and obtaining a final prediction signal by weighting the intermediate weighted prediction signal and a second prediction signal of intra prediction signal and the OBMC prediction signal; wherein the intermediate weighted prediction signal and the second prediction signal are both in one of a mapped domain or an original domain.

Embodiments of the present disclosure provide an apparatus for performing video data processing. A combined inter and intra prediction (CIIP) and luma mapping with chroma scaling (LMCS) are applied, and the apparatus includes a memory figured to store instructions; and one or more processors configured to execute the instructions to cause the apparatus to perform: obtaining an inter prediction signal, an intra prediction signal, and an overlapped block motion compensation (OBMC) prediction signal; obtaining an intermediate weighted prediction signal by weighting the inter prediction signal and a first prediction signal of the intra prediction signal and the OBMC prediction signal; and obtaining a final prediction signal by weighting the intermediate weighted prediction signal and a second prediction signal of intra prediction signal and the OBMC prediction signal; wherein the intermediate weighted prediction signal and the second prediction signal are both in one of a mapped domain or an original domain

Embodiments of the present disclosure provide a non-transitory computer-readable storage medium storing a bitstream of a video for processing according to a method, wherein a combined inter and intra prediction (CIIP) and luma mapping with chroma scaling (LMCS) are applied on the video, and the method comprises obtaining an inter prediction signal in an original domain, an intra prediction signal in a mapped domain, and an overlapped block motion compensation (OBMC) prediction signal in the original domain; obtaining an intermediate weighted prediction signal by weighting the inter prediction signal and the OBMC prediction signal in the original domain; converting the intermediate weighted prediction signal from the original domain to the mapped domain; and obtaining a final prediction signal by weighting the converted intermediate weighted prediction signal and the intra prediction signal in the mapped domain.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates angular intra prediction modes in VVC, according to some embodiments of the present disclosure.

FIG. 6 illustrates exemplary neighboring blocks used in a derivation of a general most probable mode (MPM) list, according to some embodiments of the present disclosure.

FIG. 7 illustrates exemplary pixels used for calculating gradients in decoder-side intra mode derivation (DIMD), according to some embodiments of the present disclosure.

FIG. 8 illustrates a prediction blending process of DIMD, according to some embodiments of the present disclosure.

FIG. 9 illustrates an exemplary template and its reference samples used in template-based intra mode derivation (TIMD), according to some embodiments of the present disclosure.

FIG. 10 illustrates a top neighboring block and a left neighboring block used in a combined inter and intra prediction (CIIP) weight derivation, according to some embodiments of the present disclosure.

FIG. 11 illustrates an exemplary flowchart of the extended CIIP mode using position dependent intra prediction combination (PDPC), according to some embodiments of the present disclosure.

FIGS. 12A and 12B illustrate exemplary sub-blocks applied overlapped block motion compensation (OBMC), according to some embodiments of the present disclosure.

FIG. 13 illustrates an exemplary luma mapping with chroma scaling (LMCS) architecture from decoder's perspective including luma components and chroma components, according to some embodiments of the present disclosure.

FIG. 14 illustrates an exemplary flowchart of a method for generating an intra predictor in CIIP, according to some embodiments of the present disclosure.

FIG. 15A illustrates a flowchart of an exemplary method for obtaining a final prediction signal in a mapped domain, according to some embodiments of the present disclosure.

FIG. 15B shows a table illustrating the method for obtaining a final prediction signal in a mapped domain shown in FIG. 15A, according to some embodiments of the present disclosure.

FIG. 16A illustrates a flowchart of another exemplary method for obtaining a final prediction signal in a mapped domain, according to some embodiments of the present disclosure.

FIG. 16B shows a table illustrating changes of the method for obtaining a final prediction signal in a mapped domain shown in FIG. 15B, according to some embodiments of the present disclosure.

FIG. 17A illustrates a flowchart of another exemplary method for obtaining a final prediction signal in a mapped domain, according to some embodiments of the present disclosure.

FIG. 17B shows a table illustrating changes of the method for obtaining a final prediction signal in a mapped domain shown in FIG. 15B, according to some embodiments of the present disclosure.

FIG. 18A illustrates a flowchart of another exemplary method for obtaining a final prediction signal in a mapped domain, according to some embodiments of the present disclosure.

FIG. 18B shows a table illustrating changes of the method for obtaining a final prediction signal in a mapped domain shown in FIG. 15B, according to some embodiments of the present disclosure.

FIG. 19A illustrates a flowchart of another exemplary method for obtaining a final prediction signal in a mapped domain, according to some embodiments of the present disclosure.

FIG. 19B shows a table illustrating changes of the method for obtaining a final prediction signal in a mapped domain shown in FIG. 15B, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recent, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) includes changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

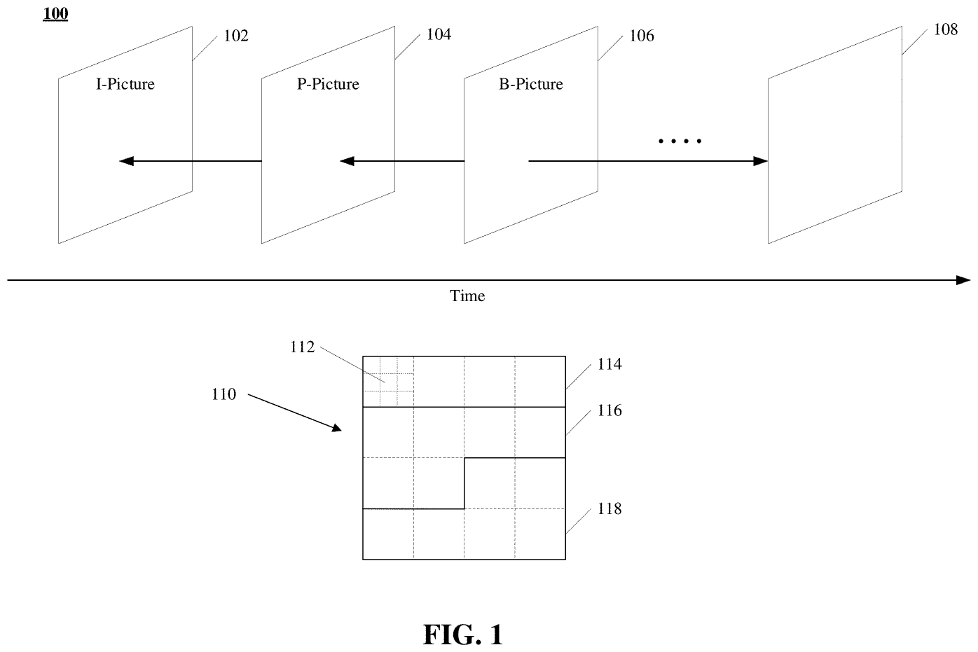

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTB s”) in some video coding standards (e.g., H.265/HEVC or H.266/VVC). Any operation performed to a basic processing unit can be repeatedly performed to each of its luma and chroma components.

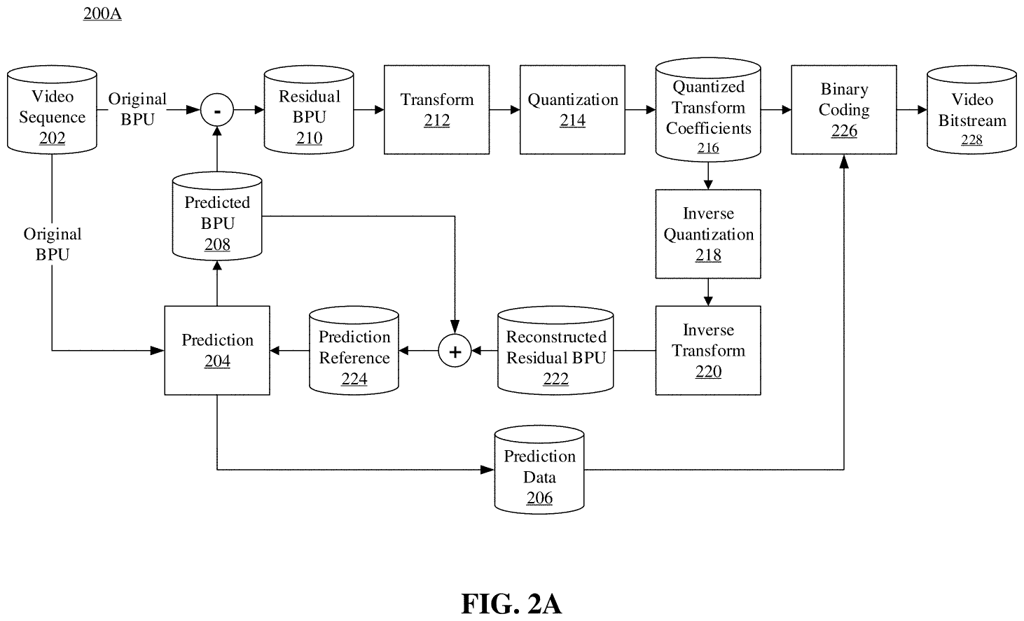

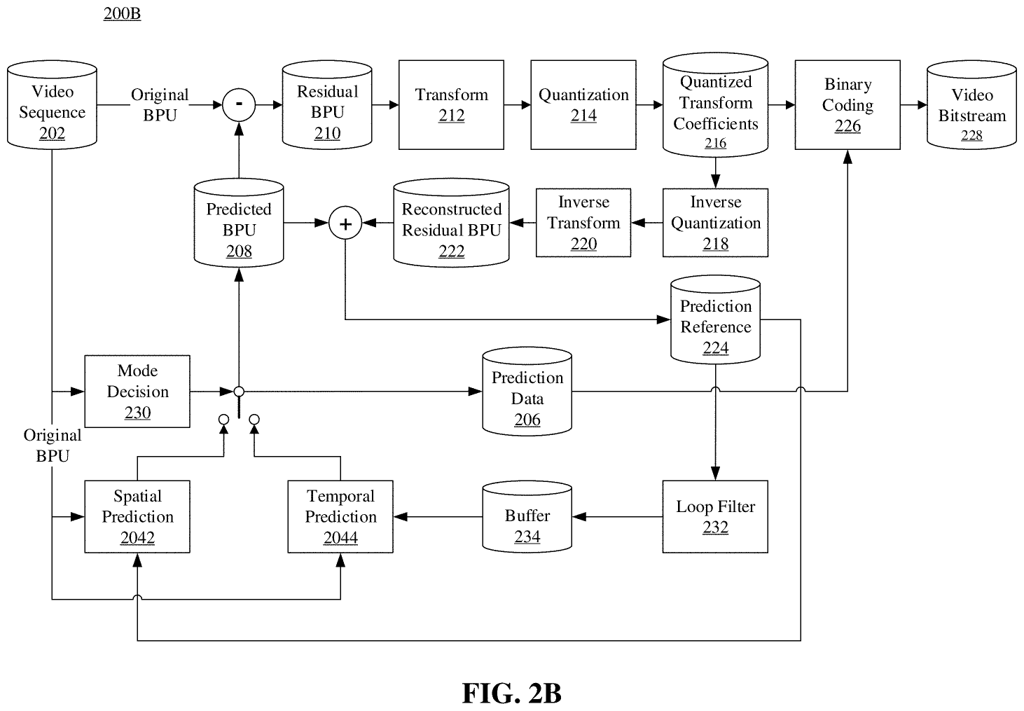

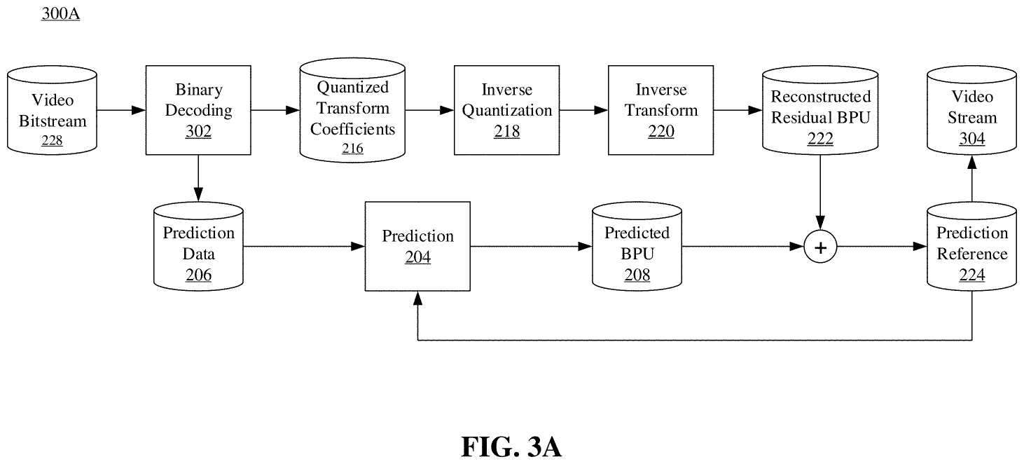

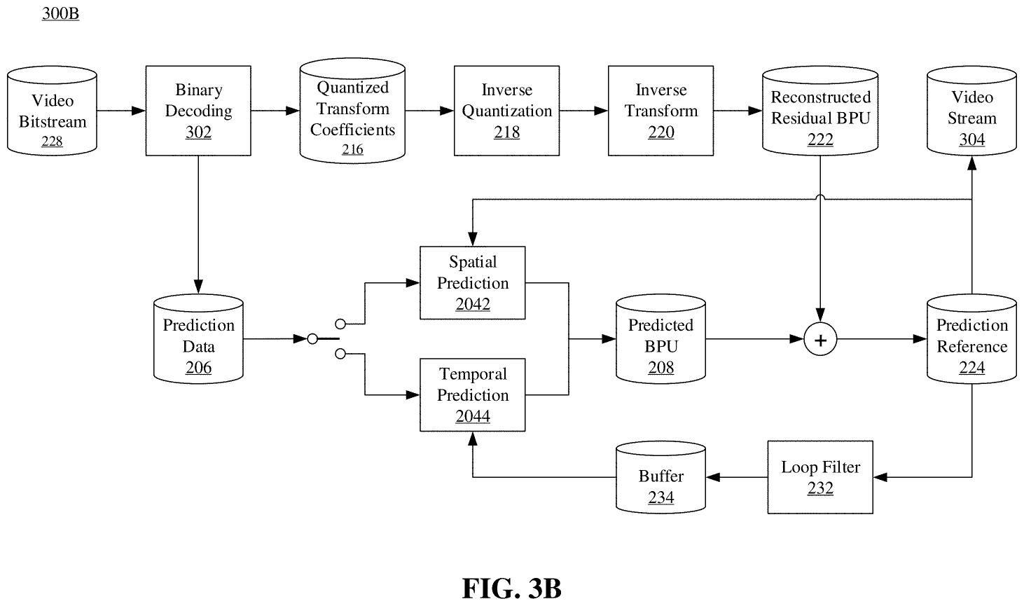

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

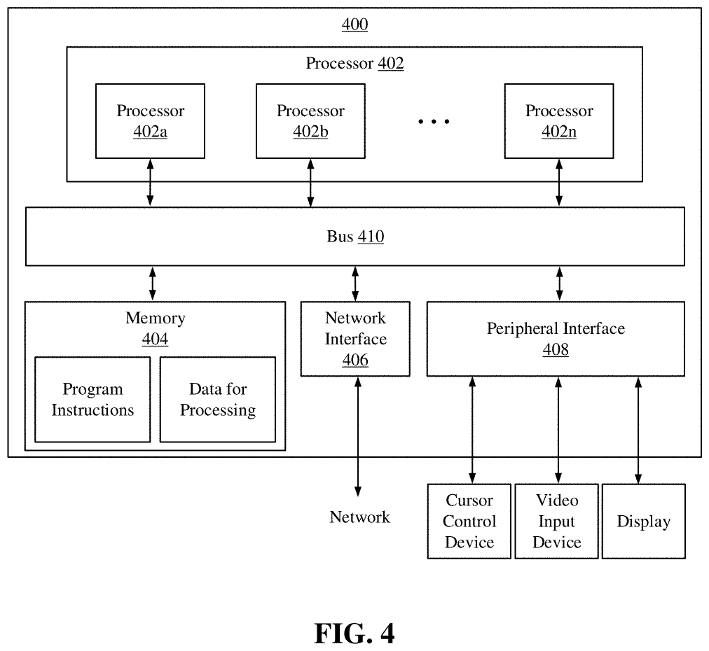

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

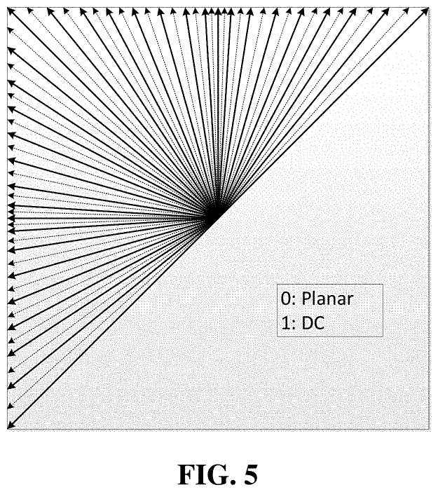

Multiple intra prediction modes are provided in VVC. FIG. 5 illustrates angular intra prediction modes in VVC, according to some embodiments of the present disclosure. As shown in FIG. 5, to capture the arbitrary edge directions presented in natural video, the number of angular intra prediction modes in VVC is extended from 33, as used in HEVC, to 65, where the directional modes not in HEVC are depicted as dotted arrows.

The VVC standard implements two non-angular intra prediction modes: DC and planar modes (as in HEVC). In the DC intra prediction mode, a mean sample value of the reference samples to the block is used for prediction generation. In VVC, the reference samples only along the longer side of a rectangular block are used to calculate the mean value, while for square blocks reference samples from both left and above sides are used. In the planar mode, the predicted sample values are obtained as a weighted average of 4 reference sample values. The reference samples in the same row or column as the current sample and the reference samples on the bottom-left and on the top-right position with respect to the current block. The 65 angular modes and the two non-angular modes can be referred to as regular intra prediction mode.

In some embodiments, a most probable mode (MPM) list is proposed. As discussed above, there are 67 angular modes in VVC. If the prediction mode of each block is encoded separately, 7 bits are required to encode the 67 modes. Therefore, a method of constructing the MPM list is adopted in VVC. In image and video coding, adjacent blocks usually have a strong correlation, so there is a high probability that the intra prediction modes of adjacent blocks are the same or similar. Therefore, the MPM list is constructed based on the intra prediction modes of left adjacent block and upper adjacent block. In VVC, the length of its MPM list is 6. In order to keep a lower complexity of the MPM list generation, an intra prediction mode coding method with 6 MPMs, which is derived from two available neighboring intra prediction modes, is used.

A unified 6-MPM list, which is also referred to as primary MPM (PMPM) list, is used for intra blocks irrespective of whether MRL (Multiple Reference Line) and ISP (Intra Sub-Partitions) coding tools are applied or not. The MPM list is constructed based on intra modes of the left and above neighboring blocks. Supposing that the intra mode of the left block is denoted as “Left” and the intra mode of the above block is denoted as “Above,” the unified 6-MPM list is constructed as follows. When a neighboring block is not available, the intra prediction mode is set to “Planar” by default. If both modes Left and Above are non-angular modes, MPM list is set to {Planar, DC, V, H, V−4, V+4}, where V is referred to as to vertical mode, and H is referred to as to horizontal mode. If one of modes Left and Above is angular mode, and the other is non-angular, a mode Max is set as the larger mode in Left and Above, and MPM list is set to {Planar, Max, Max−1, Max+1, Max−2, Max+2}. If Left and Above are both angular and they are different, a mode “Max” is set as the larger mode in Left and Above, and a mode “Min” is set as the smaller mode in Left and Above. If Max−Min is equal to 1, the MPM list is set to {Planar, Left, Above, Min−1, Max+1, Min−2}; otherwise, if Max−Min is greater than or equal to 62, the MPM list is set to {Planar, Left, Above, Min+1, Max−1, Min+2}. If Max−Min is equal to 2, the MPM list is set to {Planar, Left, Above, Min+1, Min−1, Max+1}; otherwise, the MPM list is set to {Planar, Left, Above, Min−1, Min+1, Max−1}. If Left and Above are both angular and they are the same, the MPM list is set to {Planar, Left, Left−1, Left+1, Left−2, Left+2}. Moreover, the first bin of the MPM index codeword is CABAC (Context-based Adaptive Binary Arithmetic Coding) context coded. A total three contexts are used, corresponding to whether the current intra block is MRL enabled, ISP enabled, or a normal intra block. For entropy coding of the 61 non-MPM modes, a TBC (Truncated Binary Code) is used.

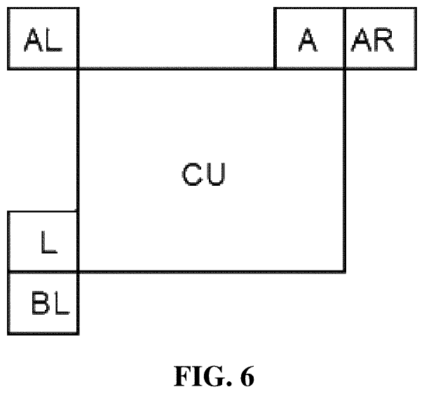

In some embodiments, a secondary MPM method can be used. The primary MPM (PMPM) list consists of 6 entries, and the secondary MPM (SMPM) list includes 16 entries. A general MPM list with 22 entries is constructed first, of which the first 6 entries are included into the PMPM list, and the rest of entries form the SMPM list. The first entry in the general MPM list is the planar mode. Then the intra prediction modes of the neighboring blocks are add into the list. FIG. 6 illustrates exemplary neighboring blocks used in a derivation of a general MPM list, according to some embodiments of the present disclosure. As shown in FIG. 6, the intra prediction modes of the left (L), above (A), below-left (BL), above-right (AR), and above-left (AL) neighboring blocks are used. If a CU block is vertically oriented, the order of neighboring blocks is A, L, BL, AR, AL. Otherwise, i.e., if the CU block is horizontally oriented, the order of neighboring blocks is L, A, BL, AR, AL. Then two decoder-side intra prediction modes are added into the list. Then, the derived angular modes by adding offset from the first two available angular modes of the list are added into the list. Finally, if the list is not complete, default modes are added until the list is complete, that is, has 22 entries. The default mode list is defined as {DC, V, H, V−4, V+4, 14, 22, 42, 58, 10, 26, 38, 62, 6, 30, 34, 66, 2, 48, 52, 16}, according to some embodiments of the present disclosure.

For a decoder, a PMPM flag is parsed first. If the PMPM flag is equal to 1, then a PMPM index is parsed to determine which entry of the PMPM list is selected; otherwise, an SMPM flag is parsed to determine whether to parse an SMPM index for the remaining modes.

In some embodiments, a position dependent intra prediction combination (PDPC) is provided. In VVC, the results of intra prediction are further modified by a PDPC method. PDPC is applied to the following intra prediction modes without signaling: Planar, DC, intra angular modes less than or equal to horizontal modes, and intra angular modes greater than or equal to vertical modes. If the current block is BDPCM (Block-based Delta Pulse Code Modulation) mode or a MRL index is greater than 0, the PDPC is not applied.

A prediction sample pred (x′, y′) is predicted using an intra prediction mode (e.g., DC, planar, or angular mode) and a linear combination of reference samples based on the following equation:

pred(x′,y′)=Clip(0, (1<<BitDepth)−1, (wL×R−1,y′+wT×Rx′,−1+(64−wL−wT)×pred(x′,y′)+32)>>6)

where Rx′,−1 and R−1,y′ represent the reference samples located at the top and left boundaries of the current sample (x′, y′), respectively. The PDPC weights and scale factors are dependent on prediction modes and the block sizes.

Furthermore, a decoder-side intra prediction mode derivation (DIMD) method is provided. In the DIMD method, a luma intra prediction mode is not transmitted via the bitstream. Instead, a texture gradient processing is performed to derive two best modes. An identical fashion is used at the encoder side and at the decoder side. The predictors of the two derived modes and planar mode are computed normally, and the weighted average of the three predictors is used as a final predictor of the current block.

The DIMD mode is used as an alternative intra prediction mode and a flag is signaled for each block to indicate whether to use DIMD mode or not. If the flag is true (e.g., the flag is equal to 1), the DIMD mode is used for the current block, and the BDPCM flag, MIP (Matrix Weighted Intra Prediction) flag, ISP flag and MRL index are inferred to be 0. In this case, an entire intra prediction mode parsing is also skipped. If the flag is false (e.g., the flag is equal to 0), the DIMD mode is not used for the current block and the parsing of the other intra prediction modes continues normally.

To derive the two intra prediction modes and determine the weight of each mode, a histogram is built by performing the texture gradient processing.

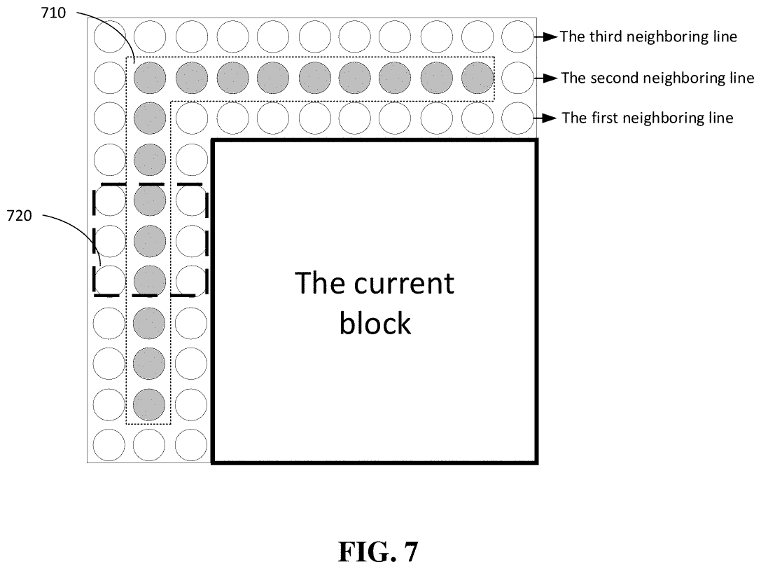

FIG. 7 illustrates exemplary samples used for calculating gradients in DIMD, according to some embodiments of the present disclosure. As shown in FIG. 7, to build a DIMD histogram for a block, a gradient analysis is performed on the samples 710 of L-shaped template of the second neighboring line surrounding the block. For each available reconstructed sample of the template, a horizontal gradient and a vertical gradient, Gx and Gy, are carried out by applying horizontal and vertical Sobel filters as follows:

$${F}_{h o r} = [ \begin{matrix}1 & 0 & - 1 \\ 2 & 0 & - 2 \\ 1 & 0 & - 1\end{matrix} ] and {F}_{v e r} = [ \begin{matrix}- 1 & - 2 & - 1 \\ 0 & 0 & 0 \\ 1 & 2 & 1\end{matrix} ]$$

The horizontal and vertical Sobel filters have a filter window 720, as shown in FIG. 7.

For each sample in the template, for which the horizontal gradient Gx and the vertical gradient Gy are calculated, the intensity (G) and the orientation (0) of the gradients are further calculated using Gx and Gy as follows:

$$G = \vert {G}_{x} \vert + \vert {G}_{y} \vert and O = atan ( \frac{{G}_{y}}{{G}_{x}} )$$

The orientation of the gradients O is converted into the closest intra angular prediction mode, and used to index a histogram that is first initialized to zero. The histogram value at that intra angular prediction mode is increased by G. After all the samples in the template have been processed, the histogram can contain cumulative values of gradient intensities, for each intra angular prediction mode. The two modes with the largest and second largest amplitude values are selected and marked as M₁ and M₂, respectively, for following prediction fusion processes. If the maximum amplitude value in the histogram is 0, the planar mode is selected as intra prediction mode for the current block.

In DIMD, the two intra prediction angular modes corresponding to the two largest histogram amplitude values, M₁ and M₂, are combined with the planar mode to generate the final prediction values of the current block.

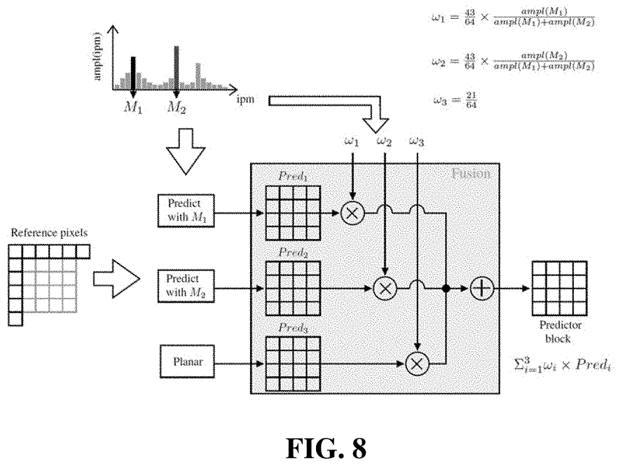

A prediction blending is applied as a weighted average of the above three predictors. The weight of planar mode is fixed to 21/64 (approximately equal to 1/3). The remaining weight of 43/64 (approximately equal to 2/3) is shared between M₁ and M₂, proportionally to the amplitude values of M₁ and M₂. FIG. 8 illustrates a prediction blending process of DIMD, according to some embodiments of the present disclosure. As shown in FIG. 8, ampl(M₁) and ampl(M₂) represent the amplitude values of M₁ and M₂, respectively.

The DIMD mode is only used for luma block. If the current luma block selects the DIMD mode, the intra prediction mode of the current block is stored as M₁ for a selection of the low-frequency non-separable transform (LFNST) sets of the current block, a derivation of the most probable modes (MPM) list of the neighboring luma block, and a derivation of the direct mode (DM) of the co-located chroma block.

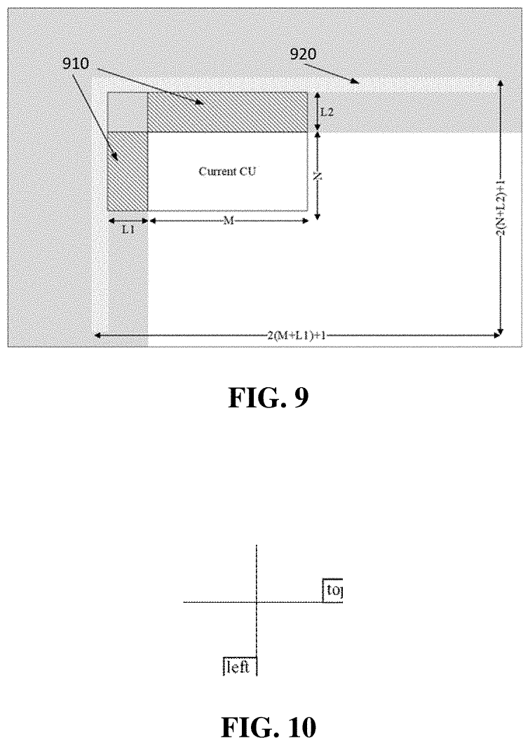

Moreover, in some embodiments, another decoder-side intra prediction mode derivation method (such as a template-based intra mode derivation (TIMD) using MPMs) can be used. The intra prediction mode of a CU is derived with a template-based method at both encoder and decoder sides, instead of being signaled. A candidate is constructed from the MPM list, and the candidate modes can be 67 intra prediction modes as in VVC or extended to 131 intra prediction modes. FIG. 9 illustrates exemplary template and reference samples used in TIMD, according to some embodiments of the present disclosure. As shown in FIG. 9, the prediction samples of the template 910 are generated using the reference samples 920 of the template for each candidate mode. A value is calculated as a sum of absolute transformed differences (SATD) between the prediction and the reconstruction samples of the template. The intra prediction mode with a minimum value of the SATD is selected as the TIMD mode and used for intra prediction of the current CU.

The TIMD mode is used as an additional intra prediction method for a CU. A flag is signaled in sequence parameter set (SPS) to enable/disable the TIMD. When the flag is true (e.g., the flag is equal to 1), a CU level flag is signaled to indicate whether the TIMD is used. The TIMD flag is signaled after a MIP flag. If the TIMD flag is true (e.g., the TIMD flag is equal to 1), the remaining syntax elements related to luma intra prediction mode, including MRL, ISP, and normal parsing stage for luma intra prediction modes, are all skipped.

Since the number of intra prediction modes is extended to 131 in the TIMD, when storing the intra prediction mode for the current block, a table is used to map the 131 modes into the original 67 intra prediction modes in the VVC.

A combined inter and intra prediction (CIIP) is provided. In VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the CIIP mode is applied to the current CU. The CIIP prediction combines an inter predictor with an intra predictor. An inter predictor in the CIIP mode Pᵢₙₜₑᵣ is derived using the same inter prediction process applied to regular merge mode, and an intra predictor Pᵢₙₜᵣₐ is derived following the regular intra prediction process with the planar mode. FIG. 10 illustrates top and left neighboring blocks used in CIIP weight derivation, according to some embodiments of the present disclosure. The intra and inter predictors are combined using weighted averaging, where the weight value is calculated depending on the coding modes of the top and left neighboring blocks (as shown in FIG. 10).

The weights (wIntra, wInter) for intra predictor and inter predictor are adaptively set as follows. If both top and left neighbors are intra-coded, (wIntra, wInter) are set equal to (3, 1). If one of these blocks is intra-coded, the weights are identical, i.e., set equal to (2, 2). If neither of the top and left neighbors is intra-coded, the weights are set equal to (1, 3). The CIIP predictor is formed based on the following:

P_{CIIP}=(wInter*Pᵢₙₜₑᵣ+wIntra*Pᵢₙₜᵣₐ+2)>>2

For chroma component, DM mode is applied without extra signaling.

In some embodiments, a multi-hypothesis prediction for intra and inter modes can be used. In a merge CU, one flag is signaled for merge mode to select an intra prediction mode from an intra candidate list when the flag is true. For luma component, the intra candidate list is derived from 4 intra prediction modes including DC, planar, horizontal, and vertical modes. One intra prediction mode selected by the intra prediction mode index and one inter prediction mode selected by the merge index are combined using weighted average. The weights for combining predictions are described as follows. When DC or planar mode is selected or the CU width or height is smaller than 4, equal weights are applied. For those CUs with CU width and height larger than or equal to 4, when a horizontal/vertical mode is selected, one CU is first vertically or horizontally split into four equal-size regions. Each weight set, denoted as (wIntrai, wInteri), where i is from 1 to 4 and (wIntra1, wInter1)=(6, 2), (wIntra2, wInter2)=(5, 3), (wIntra3, wInter3)=(3, 5), and (wIntra4, wInter4)=(2, 6), are applied to a corresponding region. (wIntra1, wInter1) is for the region closest to the reference samples and (wIntra4, wInter4) is for the region farthest away from the reference samples. The combined predictor can be calculated by summing up the two weighted predictors and right-shifting a number of bits, where the number of bits is obtained by logarithm of a sum of the two weights. In this example, the combined predictor is obtained by summing up the two weighted predictors and right-shifting 3 bits. In some embodiments, when the sum of two weights is equal to 1, the combined predictor can be obtained by summing up the two weighted predictor directly, since the logarithm of 1 is 0. There is no right-shifting needed. For example, each weight set can be (wIntra1, wInter1)=(6/8, 2/8), (wIntra2, wInter2)=(5/8, 3/8), (wIntra3, wInter3)=(3/8, 5/8), and (wIntra4, wInter4)=(2/8, 6/8), are applied to a corresponding region. (wIntra1, wInter1) is for the region closest to the reference samples and (wIntra4, wInter4) is for the region farthest away from the reference samples.

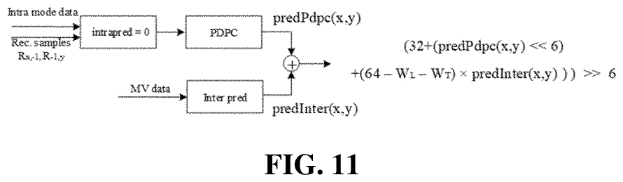

In some embodiments, a CIIP_PDPC mode can be used. In CIIP_PDPC, the prediction of the regular merge mode is refined using the above (Rx, −1) and left (−1, Ry) reconstructed samples. This refinement inherits the position dependent prediction combination (PDPC) scheme. FIG. 11 illustrates an exemplary flow chart of CIIP_PDPC, according to some embodiments of the present disclosure. Referring to FIG. 11, WT and WL are the weighted values that depend on the sample position in the block as defined in PDPC.

The CIIP_PDPC mode is signaled together with CIIP mode. When CIIP flag is true, another flag, namely CIIP_PDPC flag, is further signaled to indicate whether to use CIIP_PDPC or not.

In some embodiments, an Overlapped Block Motion Compensation (OBMC) is proposed in H.263. When OBMC is used in the Enhanced Compression Model (ECM), the OBMC is performed for all motion compensation (MC) block boundaries except the right and bottom boundaries of a CU. Moreover, the OBMC is applied for both the luma and chroma components. In the ECM, a MC block is corresponding to a coding block. When a CU is coded with sub-CU mode (such as SbTMVP (subblock-based temporal motion vector prediction) or affine mode), each sub-block of the CU is a MC block. To process CU boundaries in a uniform fashion, OBMC is performed at sub-block level for all MC block boundaries, where sub-block size is set equal to 4×4. When OBMC applies to the current sub-block, besides current motion vectors, motion vectors of four connected neighboring sub-blocks (if available and are not identical to the current motion vector) are also used to derive prediction block for the current sub-block. These multiple prediction blocks based on multiple motion vectors are combined to generate a final prediction signal of the current sub-block.

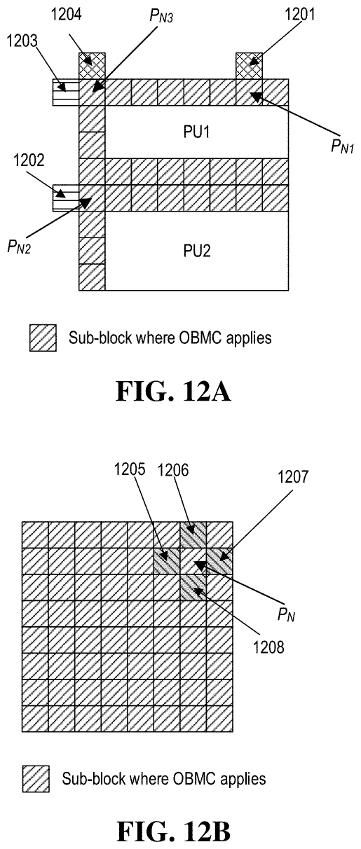

Prediction block based on motion vectors of a neighboring sub-block is denoted as P_{N}, where N indicates an index for the neighboring above, below, left and right sub-blocks. Prediction block based on motion vectors of the current sub-block is denoted as P_{C}. When P_{N} is based on the motion information of a neighboring sub-block that contains the same motion information to the current sub-block, the OBMC is not performed from P_{N}. Otherwise, every sample of P_{N} is added to the same sample in P_{C}. It is noted that a weighting factor may be applied to P_{N} before P_{N} is added to P_{C}. FIGS. 12A and 12B illustrate exemplary sub-blocks applied the OBMC, according to some embodiments of the present disclosure. For example, FIG. 12A illustrates motion vectors used in OBMC for sub-blocks at CU/PU boundaries for a currently CU. As shown in FIG. 12A, for a sub-block at top boundary P_{N1}, motion vector of above neighboring sub-block 1201 is used in OBMC of P_{N1}; for a sub-block at left boundary P_{N2}, motion vector of left neighboring sub-block 1202 is used in OBMC of P_{N2}; and for a sub-block at top-left corner P_{N3}, motion vectors of left neighboring sub-blocks 1203 and above neighboring sub-block 1204 are used in OBMC of P_{N3}. FIG. 12B illustrates motion vectors used in OBMC for sub-blocks in ATMVP (alternative temporal motion vector prediction) for a current CU. In ATMVP, each sub-block is a MC block. As shown in FIG. 12B, for a sub-block P_{N}, motion vectors of four neighboring sub-block 1205, 1206, 1207, and 1208 are used in OBMC of P_{N}.

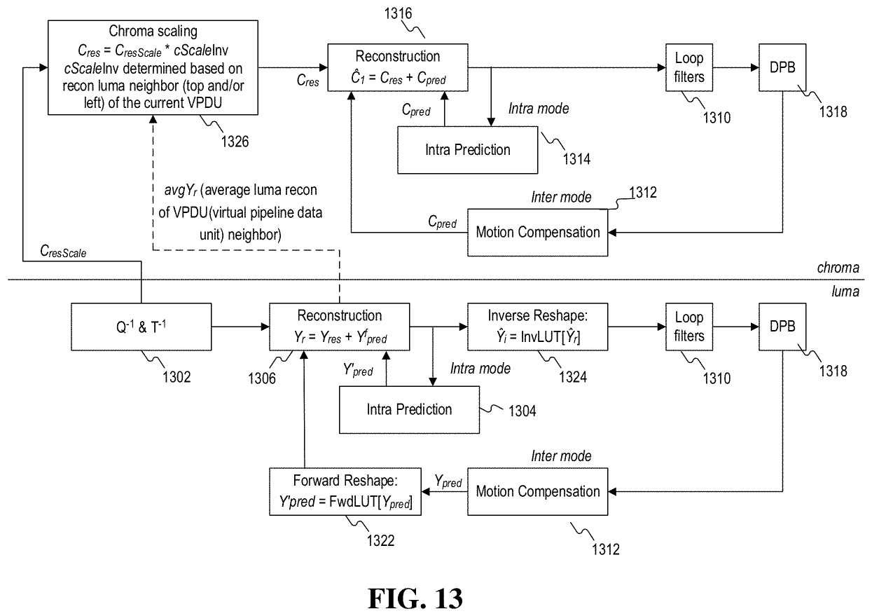

In VVC, a coding tool called luma mapping with chroma scaling (LMCS) is added as a new processing block before the loop filters. LMCS has two main components: 1) for luma components, in-loop mapping of the luma component based on adaptive piecewise linear models; 2) for chroma components, luma-dependent chroma residual scaling is applied. FIG. 13 illustrates an exemplary LMCS architecture from decoder's perspective including luma components and chroma components, according to some embodiments of the present disclosure. Referring to FIG. 13, the processing blocks 1302, 1304, and 1306 indicate where the processing is applied in a mapped domain, which include an inverse quantization and inverse transform 1302, luma intra prediction 1304, and reconstruction of luma component 1306 by adding of the luma prediction together with the luma residual. The processing blocks 1310 to 1318 indicate where the processing is applied in an original (i.e., non-mapped) domain, which include loop filters 1310 (e.g., deblocking, ALF, and SAO), motion compensated prediction 1312, chroma intra prediction 1314, reconstruction of chroma component 1316 by adding of the chroma prediction together with the chroma residual, and storage of decoded pictures as reference pictures 1318 in decoded picture buffer (DPB). The processing blocks 1322, 1324, and 1326 are the new LMCS functional blocks, which include forward mapping of the luma signal 1322, inverse mapping of the luma signal 1324, and a luma-dependent chroma scaling process 1326. As most other tools in VVC, LMCS can be enabled/disabled at the sequence level using an SPS flag.

In the current design, the CIIP mode is only applied to merge mode. That is, the inter prediction of the CIIP mode can only be derived from merge mode. However, the prediction of merge mode may not be accurate especially for a block whose motion is different from its neighboring blocks. In this case, the performance of the CIIP mode may be decreased.

To improve the prediction accuracy of the CIIP mode, the present disclosure proposes methods to apply the CIIP mode to a regular inter mode.

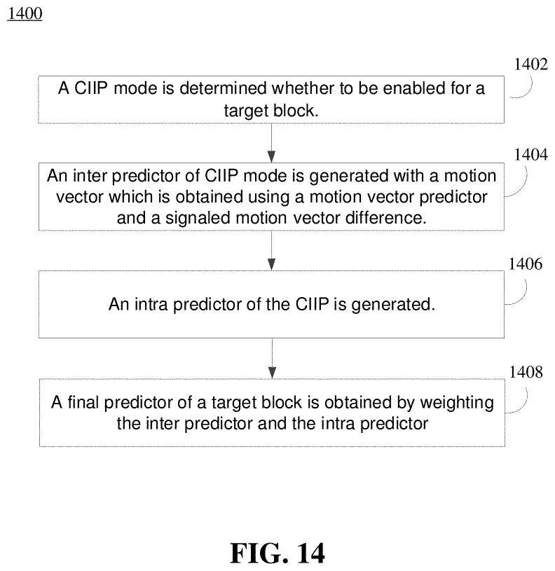

FIG. 14 illustrates an exemplary flowchart of a method 1400 for generating an intra predictor in CIIP, according to some embodiments of the present disclosure. Method 1400 can be performed by a system such as an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, one or more processors (e.g., processor 402 of FIG. 4) can perform method 1400. In some embodiments, method 1400 can be implemented by a computer program product, embodied in a computer-readable medium, including computer-executable instructions, such as program code, executed by computers (e.g., apparatus 400 of FIG. 4). Referring to FIG. 14, method 1400 may include the following steps 1402 to 1408.

At step 1402, the system can determine whether a CIIP mode is enabled for a target block. In some embodiments, a flag is signaled in a bitstream to indicate the mode used for the target block. For example, when a block is determined to be coded with regular inter mode and not coded with merge mode, a first flag is signaled to indicate whether the block is coded with the CIIP mode. A block coded with regular inter mode and CIIP mode, and not coded with merge mode, is referred to as CIIP_INTER mode. When the CIIP_INTER mode is applied to a block, some other inter prediction modes, such as a local illumination compensation mode, a bi-prediction with CU-level weight mode, an affine mode, a symmetric motion vector difference mode, an adaptive motion vector resolution mode, or a multi-hypothesis inter prediction mode, may be disabled.

In some embodiments, the first flag is decoded at the end of the whole regular inter mode syntax structure. In this example, the first flag is signaled only when local illumination compensation mode, bi-prediction with CU-level weight mode, affine mode, or multi-hypothesis inter prediction mode are disabled.

In some embodiments, the first flag is decoded at the beginning of the whole regular inter mode syntax structure. When the first flag indicates the CIIP_INTER mode is applied (for example, the first flag is true), the local illumination compensation mode, bi-prediction with CU-level weight mode, affine mode, or multi-hypothesis inter prediction mode are disabled, and related syntax of these modes are not signaled.

At step 1404, an inter predictor (also referred as to an inter prediction signal) of CIIP mode is generated with a motion vector that is obtained using a motion vector predictor and a signaled motion vector difference. Therefore, the inter prediction of the CIIP for a block having motion that is different from its neighboring blocks can be more accurate.

In some embodiments, the CIIP mode is combined with merge mode with motion vector difference (referred to as MMVD). The inter prediction of the CIIP mode is predicted with the MMVD mode (referred to as CIIP_MMVD). In some embodiments, for a block coded with the MMVD mode, in step 1402, a second flag indicating whether the block is coded with the CIIP_MMVD mode is decoded. In some embodiments, for a block coded with the CIIP mode, in step 1404, a third flag indicating whether the inter prediction is predicted using the CIIP_MMVD mode is decoded.

At step 1406, an intra predictor (also referred as to an intra prediction signal) of the CIIP is generated. In some embodiments, the intra prediction of the CIIP mode is derived using TIMD or DIMD methods instead of planar mode. In some embodiments, when the CIIP_INTER or CIIP_MMVD modes are enabled, the intra prediction is derived using the TIMD or DIMD modes. That is, the TIMD or DIMD method is used to derive an intra prediction mode. Moreover, the intra prediction mode is propagated to neighboring blocks which are coded with the CIIP mode.

At step 1408, a final predictor (also referred as to a final prediction signal) of a target block is obtained by weighting the inter predictor and the intra predictor.

Therefore, the CIIP mode can be applied with various modes. The inter prediction of the CIIP for a block whose motion is different from its neighboring blocks can be more accurate, and the performance of CIIP is improved.

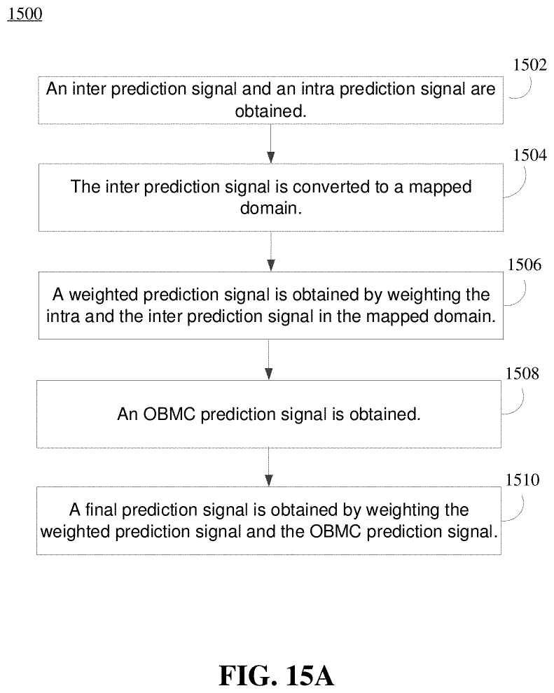

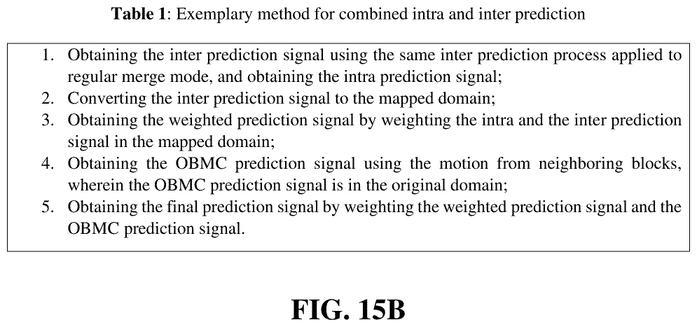

In some embodiments, when a block coded with CIIP and LMCS modes, the OBMC mode is always applied. FIG. 15A illustrates a flowchart of an exemplary method 1500 for obtaining a final prediction signal in a mapped domain, according to some embodiments of the present disclosure. Method 1500 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1500. In some embodiments, method 1500 can be implemented by a computer program product, embodied in a computer-readable medium, including computer-executable instructions, such as program code, executed by computers (e.g., apparatus 400 of FIG. 4). Referring to FIG. 15A, method 1500 may include the following steps 1502 to 1510.

At step 1502, an inter prediction signal and an intra prediction signal are obtained. The inter prediction signal is obtained using the same inter prediction process applied to regular merge mode. Referring to FIG. 14, the inter prediction signal and the intra prediction signal can be obtained as the same steps to obtain an inter predictor and intra prediction in steps 1402 to 1406. Consistent with FIG. 13, the inter prediction signal is obtained in an original domain (e.g., block 1312), and the intra prediction signal is obtained in a mapped domain (e.g., block 1304).

At step 1504, the inter prediction signal is converted from the original domain to the mapped domain. Therefore, both the inter prediction signal and the intra prediction signal are in a same domain, i.e., the mapped domain.

At step 1506, a weighted prediction signal is obtained by weighting the intra and the inter prediction signal in the mapped domain.

At step 1508, an OBMC prediction signal is obtained. The OBMC prediction signal is obtained using a motion from neighboring blocks, and the OBMC prediction signal is in the original domain.

At step 1510, a final prediction signal is obtained by weighting the weighted prediction signal and the OBMC prediction signal.

The method 1500 can also be illustrated in Table 1 in FIG. 15B. As shown in FIGS. 15A and 15B, in method 1500, the weighted prediction signal is obtained in the mapped domain at step 1506, while the OBMC is obtained in the original domain. The OBMC prediction signal is not converted into the mapped domain before weighting. Therefore, the final prediction signal is obtained by weighting two signals in different domains.

To improve the weighting process of a block coded with the CIIP, OBMC and LMCS modes, the present disclosure proposes methods for improving the weighting process. For example, prediction signals used in weighting process are converted into a same domain, e.g., both the prediction signals are in the mapped domain, or both the prediction signals are in the original domain.

In some embodiments, two prediction signals of an inter prediction signal, an intra prediction signal, and an OBMC prediction signal can be weighted to obtain an intermediate prediction signal. Then, the intermediate prediction signal can be further weighted with a third prediction signal to obtain a final prediction signal. The final prediction signal is in the mapped domain.

For example, in a first weighting processing, the inter prediction signal and the intra prediction signal can be first weighted to obtain the intermediate prediction signal (e.g., a weighted prediction signal). Then, in a second weighting processing, the intermediate prediction signal (e.g., the weighted prediction signal) and the OBMC prediction signal are weighted to obtain the final prediction signal. In another example, in the first weighting processing, the inter prediction signal and the OBMC prediction signal can be first weighted to obtain the intermediate prediction signal (e.g., a refined prediction signal). Then, in the second weighting processing, the intermediate prediction signal (e.g., the refined prediction signal) and the intra prediction signal are weighted to obtain the final prediction signal. In another example, in the first weighting processing, the intra prediction signal and the OBMC prediction signal can be first weighted to obtain the intermediate prediction signal (e.g., a refined prediction signal). Then, in the second weighting processing, the intermediate prediction signal (e.g., the refined prediction signal) and the inter prediction signal are weighted to obtain the final prediction signal. The prediction signals can be converted between an original domain and a mapped domain, such that the two prediction signals weighted in the first weighting process and the second weighting process can be in a same domain.

Further details will be further described hereinafter.

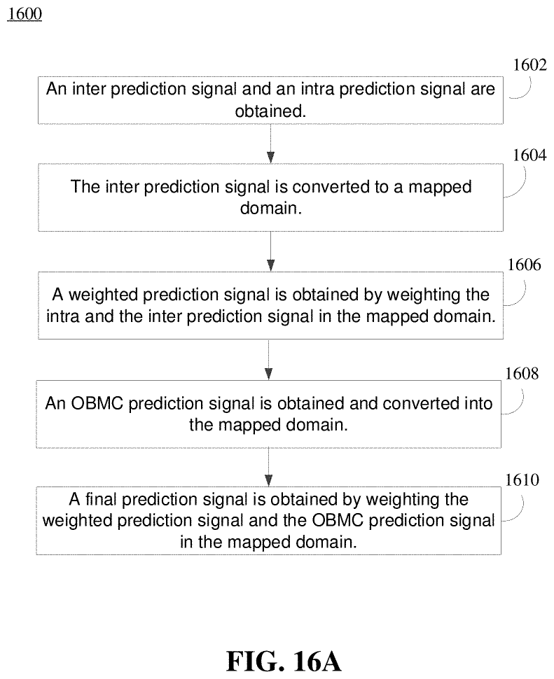

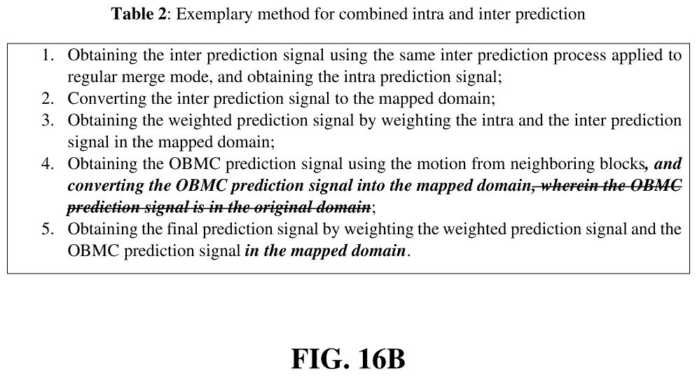

In some embodiments, the OBMC prediction signaled is converted into the mapped domain before weighting. FIG. 16A illustrates a flowchart of another exemplary method 1600 for obtaining a final prediction signal in a mapped domain, according to some embodiments of the present disclosure. Method 1600 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1600. In some embodiments, method 1600 can be implemented by a computer program product, embodied in a computer-readable medium, including computer-executable instructions, such as program code, executed by computers (e.g., apparatus 400 of FIG. 4). Referring to FIG. 16A, method 1600 may include the following steps 1602 to 1610.

At step 1602, an inter prediction signal and an intra prediction signal are obtained. The inter prediction signal is obtained using the same inter prediction process applied to regular merge mode. For example, referring to FIG. 14, the inter prediction signal and the intra prediction signal can be obtained as the same steps to obtain an inter predictor and intra prediction in steps 1402 to 1406. The inter prediction signal is obtained in an original domain, and the intra prediction signal is obtained in a mapped domain.

At step 1604, the inter prediction signal is converted for the original domain to the mapped domain. Therefore, both the inter prediction signal and the intra prediction signal are in a same domain, i.e., the mapped domain.

At step 1606, a weighted prediction signal is obtained by weighting the intra and the inter prediction signal in the mapped domain.

At step 1608, an OBMC prediction signal is obtained and converted into the mapped domain. The OBMC prediction signal is obtained using motion from neighboring blocks in the original domain. After the conversion, the OBMC prediction signal is also in the mapped domain.

At step 1610, a final prediction signal is obtained by weighting the weighted prediction signal and the OBMC prediction signal in the mapped domain. With method 1600, the weighted prediction signal and the OBMC prediction signal used for weighting process both are in mapped domain. Since the weighted prediction signal and the OBMC prediction signal are in a same domain, the weighting process can be more efficient and accurate.

The method 1600 can be illustrated in Table 2 in FIG. 16B, where differences from Table 1 shown in FIG. 15B are shown in italics, bold, and/or strikethrough.

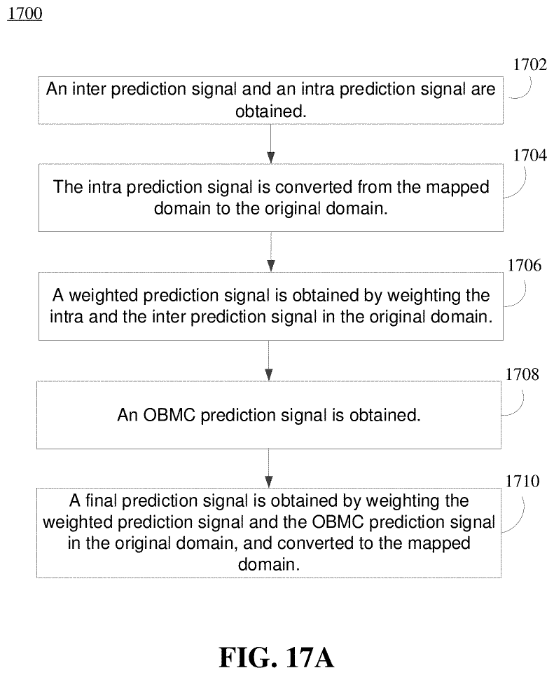

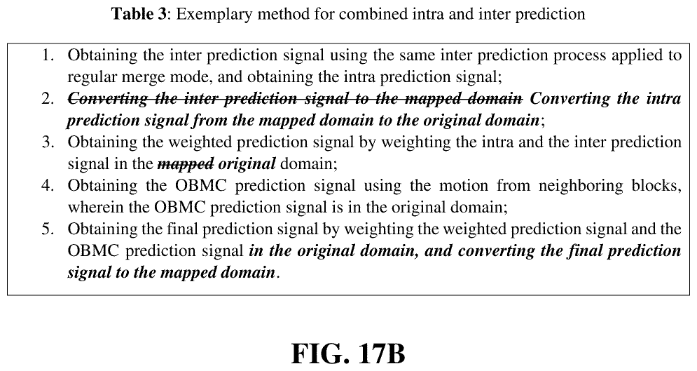

In some embodiments, instead of performing weighting in the mapped domain, performing weighting in the original domain is proposed. FIG. 17A illustrates a flowchart of another exemplary method 1700 for obtaining a final prediction signal in a mapped domain, according to some embodiments of the present disclosure. Method 1700 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1700. In some embodiments, method 1700 can be implemented by a computer program product, embodied in a computer-readable medium, including computer-executable instructions, such as program code, executed by computers (e.g., apparatus 400 of FIG. 4). Referring to FIG. 17A, method 1700 may include the following steps 1702 to 1710.

At step 1702, an inter prediction signal and an intra prediction signal are obtained. The inter prediction signal is obtained using the same inter prediction process applied to regular merge mode. For example, referring to FIG. 14, the inter prediction signal and the intra prediction signal can be obtained as the same steps to obtain an inter predictor and intra prediction in steps 1402 to 1406. The inter prediction signal is obtained in an original domain, and the intra prediction signal is obtained in a mapped domain.

At step 1704, the intra prediction signal is converted from the mapped domain to the original domain. Therefore, the intra prediction signal is in the original domain. Both the inter prediction signal and the intra prediction signal are in a same domain, i.e., original domain in this example.

At step 1706, a weighted prediction signal is obtained by weighting the intra and the inter prediction signal in the original domain. Since both the inter prediction signal and the intra prediction signal are in the original domain, the weighted prediction signal is also obtained in the original domain.

At step 1708, an OBMC prediction signal is obtained. The OBMC prediction signal is obtained using the motion from neighboring blocks, and the OBMC prediction signal is in the original domain.

At step 1710, a final prediction signal is obtained by weighting the weighted prediction signal and the OBMC prediction signal in the original domain, and converted to the mapped domain.

In method 1700, instead of converting the inter prediction signal from the original domain to the mapped domain, the intra prediction signal is converted from a mapped domain to an original domain, to make sure both the inter prediction signal and the intra prediction signal are in a same domain. Therefore, the weighted prediction signal is obtained in the original domain, the same as the OBMC prediction signal. Since the weighted prediction signal and the OBMC prediction signal in a same domain, the weighting process can be more efficient and accuracy. The final prediction signal is converted into the mapped domain after being obtained in the original domain.

The method 1700 can be illustrated in Table 3 in FIG. 17B, where differences from Table 1 shown in FIG. 15B are shown in italics, bold, and/or strikethrough).

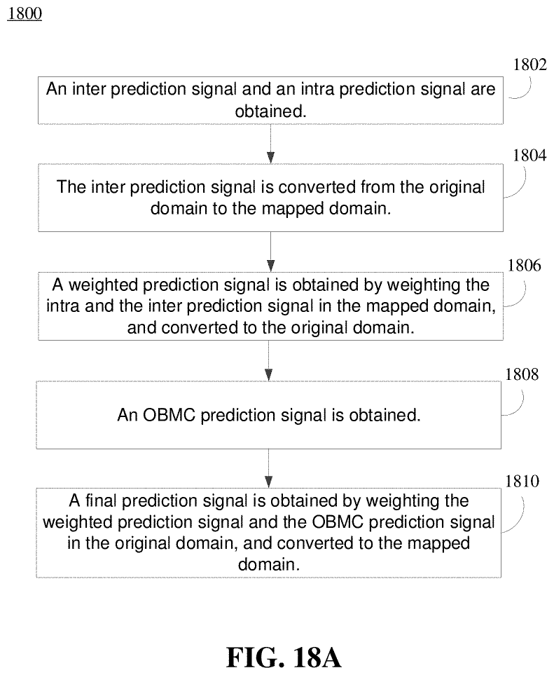

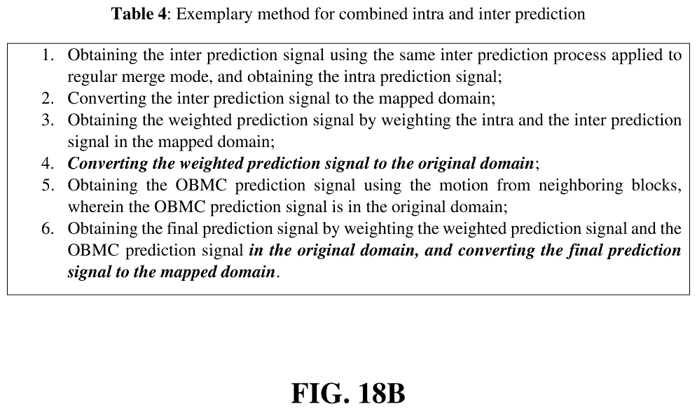

In some embodiments, a method to convert the weighted prediction signal from the mapped domain to the original domain before weighting is proposed. FIG. 18A illustrates a flowchart of another exemplary method 1800 for obtaining a final prediction signal in a mapped domain, according to some embodiments of the present disclosure. Method 1800 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1800. In some embodiments, method 1800 can be implemented by a computer program product, embodied in a computer-readable medium, including computer-executable instructions, such as program code, executed by computers (e.g., apparatus 400 of FIG. 4). Referring to FIG. 18A, method 1800 may include the following steps 1802 to 1810.

At step 1802, an inter prediction signal and an intra prediction signal are obtained. The inter prediction signal is obtained using the same inter prediction process applied to regular merge mode. For example, referring to FIG. 14, the inter prediction signal and the intra prediction signal can be obtained as the same steps to obtain an inter predictor and intra prediction in steps 1402 to 1406. The inter prediction signal is obtained in an original domain, and the intra prediction signal is obtained in a mapped domain.

At step 1804, the inter prediction signal is converted from the original domain to the mapped domain. Therefore, both the inter prediction signal and the intra prediction signal are in a same domain, i.e., the mapped domain.

At step 1806, a weighted prediction signal is obtained by weighting the intra and the inter prediction signal in the mapped domain, and converted to the original domain.

At step 1808, an OBMC prediction signal is obtained. The OBMC prediction signal is obtained using a motion from neighboring blocks, and the OBMC prediction signal is in the original domain. Therefore, both the weighted prediction signal and the OBMC prediction signal are in a same domain, i.e., the original domain.

At step 1810, a final prediction signal is obtained by weighting the weighted prediction signal and the OBMC prediction signal in the original domain, and converted to the mapped domain. With method 1800, the weighted prediction signal and the OBMC prediction signal used for weighting process both are in original domain. After the final prediction signal obtained in the original domain, the final prediction signal is converted to the mapped domain. With the weighted prediction signal and the OBMC prediction signal in a same domain, the weighting process can be more efficient and accuracy.

The method 1800 can be illustrated in Table 4 in FIG. 18B, where differences from Table 1 shown in FIG. 15B are shown in italics, bold, and/or strikethrough.

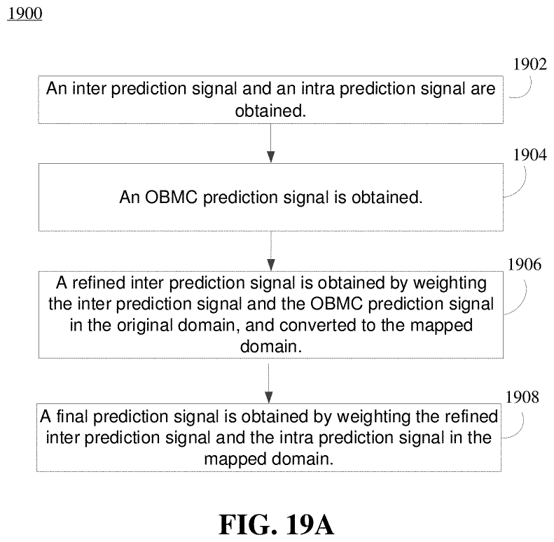

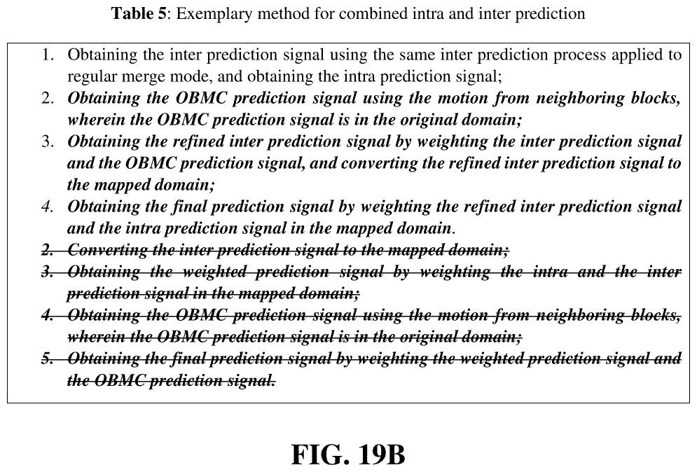

In some embodiments, a method to weight the inter prediction signal with the OBMC prediction signal prior to the intra prediction signal is proposed. FIG. 19A illustrates a flowchart of another exemplary method 1900 for obtaining a final prediction signal in a mapped domain, according to some embodiments of the present disclosure. Method 1900 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1900. In some embodiments, method 1900 can be implemented by a computer program product, embodied in a computer-readable medium, including computer-executable instructions, such as program code, executed by computers (e.g., apparatus 400 of FIG. 4). Referring to FIG. 19A, method 1900 may include the following steps 1902 to 1908.

At step 1902, an inter prediction signal and an intra prediction signal are obtained. The inter prediction signal is obtained using the same inter prediction process applied to regular merge mode. For example, referring to FIG. 14, the inter prediction signal and the intra prediction signal can be obtained as the same steps to obtain an inter predictor and intra prediction in steps 1402 to 1406. The inter prediction signal is obtained in an original domain, and the intra prediction signal is obtained in a mapped domain.

At step 1904, an OBMC prediction signal is obtained. The OBMC prediction signal is obtained using the motion from neighboring blocks, wherein the OBMC prediction signal is in the original domain.

At step 1906, a refined inter prediction signal is obtained by weighting the inter prediction signal and the OBMC prediction signal in the original domain, and converted to the mapped domain. Therefore, the refined inter prediction is first obtained in the original domain, and then converted into the mapped domain.

At step 1908, a final prediction signal is obtained by weighting the refined inter prediction signal and the intra prediction signal in the mapped domain. Since in step 1906, the refined inter prediction signal is converted to the mapped domain, the refined inter prediction and the intra prediction signal are both in a same domain, i.e., the mapped domain. Therefore, weighting process can be more efficient and accuracy.

The method 1900 can be illustrated in Table 5 in FIG. 19B, where differences from Table 1 shown in FIG. 15B are shown in italics, bold, and/or strikethrough.

In some embodiments, for a block coded with CIIP mode, the OBMC mode is disabled. For example, when a block is coded with CIIP, a flag indicating whether OBMC mode is applied or not is not signaled, and is inferred to be false, i.e., the OBMC mode is disabled. In some embodiments, the flag indicating whether OBMC mode is applicated or not is signaled with a value of the flag being false. The LMCS can be enabled for the block as well.

In some embodiments, when LMCS is enabled for a block, frame, picture, slice, or tile, the CIIP is disabled. Therefore, LMCS and CIIP cannot enabled at the same time. For example, a flag indicating whether CIIP mode is applied or not is not signaled and is inferred to be false, i.e., the CIIP mode is disabled. In some embodiments, the flag indicating whether CIIP mode is applicated or not is signaled with a value of the flag being false. The OBMC can be enabled for the current block, frame, picture, slice, or tile.

The aforementioned embodiments can be combined in any combinations.

The embodiments may further be described using the following clauses:

1. A method for video processing, wherein a combined inter and intra prediction (CIIP) and luma mapping with chroma scaling (LMCS) are applied, the method comprises:
obtaining an inter prediction signal, an intra prediction signal, and an overlapped block motion compensation (OBMC) prediction signal;
obtaining an intermediate weighted prediction signal by weighting the inter prediction signal and a first prediction signal of the intra prediction signal and the OBMC prediction signal; and
obtaining a final prediction signal by weighting the intermediate weighted prediction signal and a second prediction signal of intra prediction signal and the OBMC prediction signal;
wherein the intermediate weighted prediction signal and the second prediction signal are both in one of a mapped domain or an original domain.

2. The method according to clause 1, wherein obtaining the inter prediction signal, the intra prediction signal, and the OBMC prediction signal further comprises:
obtaining the inter prediction signal in an original domain;
obtaining the intra prediction signal in a mapped domain; and
obtaining the OBMC prediction signal in the original domain.

3. The method according to clause 2, wherein obtaining the intermediate weighted prediction signal by weighting the inter prediction signal and the first prediction signal of the intra prediction signal and the OBMC prediction signal comprises:
converting the inter prediction signal from the original domain to the mapped domain; and
obtaining the intermediate weighted prediction signal by weighting the converted inter prediction signal and the intra prediction signal in the mapped domain; and

wherein obtaining the final prediction signal by weighting the intermediate weighted prediction signal and the second prediction signal of intra prediction signal and the OBMC prediction signal further comprises:
converting the OBMC prediction signal from the original domain to the mapped domain; and
obtaining the final prediction signal by weighting the intermediate weighted prediction signal and the OBMC prediction signal in the mapped domain.

4. The method according to clause 2, wherein obtaining the intermediate weighted prediction signal by weighting the inter prediction signal and the first prediction signal of the intra prediction signal and the OBMC prediction signal comprises:
converting the inter prediction signal from the original domain to the mapped domain; and
obtaining the intermediate weighted prediction signal by weighting the converted inter prediction signal and the intra prediction signal in the mapped domain; and

wherein obtaining the final prediction signal by weighting the intermediate weighted prediction signal and the second prediction signal of intra prediction signal and the OBMC prediction signal further comprises:
converting the intermediate weighted prediction signal from the mapped domain to the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

5. The method according to clause 2, wherein obtaining the intermediate weighted prediction signal by weighting the inter prediction signal and a first prediction signal of the intra prediction signal and the OBMC prediction signal comprises:
converting the intra prediction signal from the mapped domain to the original domain; and
obtaining the intermediate weighted prediction signal by weighting the inter prediction signal and the converted intra prediction signal in the original domain; and

wherein obtaining the final prediction signal by weighting the intermediate weighted prediction signal and the second prediction signal of intra prediction signal and the OBMC prediction signal further comprises:
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

6. The method according to clause 2, wherein obtaining the intermediate weighted prediction signal by weighting the inter prediction signal and a first prediction signal of the intra prediction signal and the OBMC prediction signal comprises:
obtaining the intermediate weighted prediction signal by weighting the inter prediction signal and the OBMC prediction signal in the original domain; and

wherein obtaining the final prediction signal by weighting the intermediate weighted prediction signal and the second prediction signal of intra prediction signal and the OBMC prediction signal further comprises:
converting the intermediate weighted prediction signal from the original domain to the mapped domain; and
obtaining the final prediction signal by weighting the converted intermediate weighted prediction signal and the intra prediction signal in the mapped domain.

7. The method according to any one of clauses 1 to 6, wherein the inter prediction signal is obtained using an inter prediction process applied to a regular merge mode.

8. The method according to any one of clauses 1 to 7, wherein the OBMC prediction signal is obtained using a motion from neighboring blocks.

9. A method for video processing, comprising:
receiving a bitstream associated with a target block;
determining whether the target block is coded with a combined inter and intra prediction (CIIP) mode;
determining an overlapped block motion compensation (OBMC) mode being not applied, when the current block is coded with the CIIP mode; and
processing the target block with the CIIP mode and a luma mapping with chroma scaling (LMCS).

10. A method for video processing, comprising:
receiving a bitstream associated with a target block;
determining whether a luma mapping with chroma scaling (LMCS) is enabled for the target block;
in response to the LMCS being enabled, determining that a combined inter and intra prediction (CIIP) mode is not applied; and
processing the target block with the LMCS and an overlapped block motion compensation (OBMC) mode.

11. A method for video processing, comprising:
determining a combined inter and intra prediction (CIIP) mode being enabled for a target block;
determining an inter predictor with a motion vector, wherein the motion vector is obtained using a motion vector predictor and a signaled motion vector difference;
determining an intra predictor; and
obtaining a final predictor of the target block by weighting the inter predictor and the intra predictor.

12. The method according to clause 11, wherein the target block is coded with a regular inter mode and not coded with a merge mode.

13. The method according to clause 12, wherein inter modes except the regular inter mode are disabled.

14. The method according to clause 13, wherein the inter modes comprises one or more of a local illumination compensation mode, a bi-prediction with coding unit-level weight mode, an affine mode, a symmetric motion vector difference mode, an adaptive motion vector resolution mode, or a multi-hypothesis inter prediction mode.

15. The method according to any one of clauses 12 to 14, wherein determining the CIIP mode being enabled for the target block further comprising:

determining the CIIP mode being enabled for the target block based on a flag.

16. The method according to clause 15, wherein the flag is decoded at a beginning of a regular inter mode syntax structure.

17. The method according to clause 15, wherein the flag is decoded at an end of a regular inter mode syntax structure.

18. The method according to any one of clauses 11 to 17, wherein the inter predictor is generated using a merge mode with motion vector difference (MMVD) method.

19. The method according to any one of clauses 11 to 18, wherein the intra predictor is generated using a template-based intra mode derivation (TIMD) method or a decoder-side intra mode derivation (DIMD) method.

20. A non-transitory computer readable medium storing a bitstream comprising:

a flag associated with encoded video data, the flag indicating a combined inter and intra prediction (CIIP) is used for the encoded video data, wherein a target block is coded with a regular inter mode and not coded with a merge mode, and the flag is configured to cause a decoder to decode the target block using the CIIP mode and disable inter modes except the regular inter mode.

22. The non-transitory computer readable medium according to clause 20, wherein the flag is at a beginning of a regular inter mode syntax structure.

23. The non-transitory computer readable medium according to clause 20, wherein the flag is at an end of a regular inter mode syntax structure.

24. A non-transitory computer readable medium storing a bitstream comprising:

a flag associated with encoded video data, the flag indicating a target block is coded with a combined inter and intra prediction (CIIP) combined with a merge mode with motion vector difference (MMVD) mode, and the flag is configured to cause a decoder to decode the target block using the CIIP mode and obtain an inter predictor using the MMVD mode.

25. A non-transitory computer readable medium storing a bitstream comprising:

a flag associated with encoded video data, the flag indicating a combined inter and intra prediction (CIIP) combined with a merge mode with motion vector difference (MMVD) mode is used for an inter prediction, the flag is configured to cause a decoder to decode the target block using CIIP mode and obtain an inter predictor using the MMVD mode.

26. A non-transitory computer readable medium storing a bitstream comprising:

a first flag associated with encoded video data and indicating whether a combined inter and intra prediction (CIIP) mode is enabled; and

a second flag associated with the encoded video data and indicating whether an overlapped block motion compensation (OBMC) mode is applied,

wherein when the first flag is true, the second flag is inferred to be false.

27. A non-transitory computer readable medium storing a bitstream comprising:

a first flag associated with encoded video data and indicating whether luma mapping with chroma scaling (LMCS) is enabled; and

a second flag associated with the encoded video data and indicating whether a combined inter and intra prediction (CIIP) is enabled,

wherein when the first flag is true, the second flag is inferred to be false.

28. A non-transitory computer readable medium storing a bitstream comprising:

a first flag associated with encoded video data and indicating whether luma mapping with chroma scaling (LMCS) is enabled; and

a second flag associated with the encoded video data and indicating whether a combined inter and intra prediction (CIIP) is enabled,

wherein when both the first flag and the second flag are true, a decoder is configured to perform:
obtaining an inter prediction signal in an original domain, an intra prediction signal in a mapped domain, and an overlapped block motion compensation (OBMC) prediction signal in the original domain;
obtaining an intermediate weighted prediction signal by weighting the inter prediction signal and the OBMC prediction signal in the original domain;
converting the intermediate weighted prediction signal from the original domain to the mapped domain; and
obtaining a final prediction signal by weighting the converted intermediate weighted prediction signal and the intra prediction signal in the mapped domain.

29. An apparatus for performing video data processing, wherein a combined inter and intra prediction (CIIP) and luma mapping with chroma scaling (LMCS) are applied, the apparatus comprising:

a memory figured to store instructions; and

one or more processors configured to execute the instructions to cause the apparatus to perform:
obtaining an inter prediction signal, an intra prediction signal, and an overlapped block motion compensation (OBMC) prediction signal;
obtaining an intermediate weighted prediction signal by weighting the inter prediction signal and a first prediction signal of the intra prediction signal and the OBMC prediction signal; and
obtaining a final prediction signal by weighting the intermediate weighted prediction signal and a second prediction signal of intra prediction signal and the OBMC prediction signal;
wherein the intermediate weighted prediction signal and the second prediction signal are both in one of a mapped domain or an original domain.

30. The apparatus according to clause 29, wherein the one or more processors are further configured to execute the instructions to cause the apparatus to perform:
obtaining the inter prediction signal in an original domain;
obtaining the intra prediction signal in a mapped domain; and
obtaining the OBMC prediction signal in the original domain.

31. The apparatus according to clause 30, wherein the one or more processors are further configured to execute the instructions to cause the apparatus to perform:
converting the inter prediction signal from the original domain to the mapped domain;
obtaining the intermediate weighted prediction signal by weighting the converted inter prediction signal and the intra prediction signal in the mapped domain;
converting the OBMC prediction signal from the original domain to the mapped domain; and
obtaining the final prediction signal by weighting the intermediate weighted prediction signal and the OBMC prediction signal in the mapped domain.

32. The apparatus according to clause 30, wherein the one or more processors are further configured to execute the instructions to cause the apparatus to perform:
converting the inter prediction signal from the original domain to the mapped domain; and
obtaining the intermediate weighted prediction signal by weighting the converted inter prediction signal and the intra prediction signal in the mapped domain;
converting the intermediate weighted prediction signal from the mapped domain to the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

33. The apparatus according to clause 30, wherein the one or more processors are further configured to execute the instructions to cause the apparatus to perform:

converting the intra prediction signal from the mapped domain to the original domain;

obtaining the intermediate weighted prediction signal by weighting the inter prediction signal and the converted intra prediction signal in the original domain;

obtaining an intermediate final prediction signal by weighting the intermediate weighted prediction signal and the OBMC prediction signal in the original domain; and

obtaining the final prediction signal by converting the intermediate final prediction signal from the original domain to the mapped domain.

34. The apparatus according to clause 30, wherein the one or more processors are further configured to execute the instructions to cause the apparatus to perform:

obtaining the intermediate weighted prediction signal by weighting the inter prediction signal and the OBMC prediction signal in the original domain;

converting the intermediate weighted prediction signal from the original domain to the mapped domain; and

obtaining the final prediction signal by weighting the converted intermediate weighted prediction signal and the intra prediction signal in the mapped domain.

35. The apparatus according to any one of clauses 29 to 34, wherein the inter prediction signal is obtained using an inter prediction process applied to a regular merge mode.

36. The apparatus according to any one of clauses 29 to 35, wherein the OBMC prediction signal is obtained using a motion from neighboring blocks.

37. An apparatus for performing video data processing, the apparatus comprising:

a memory figured to store instructions; and

one or more processors configured to execute the instructions to cause the apparatus to perform:
receiving a bitstream associated with a target block;
determining whether the target block is coded with a combined inter and intra prediction (CIIP) mode;
determining an overlapped block motion compensation (OBMC) mode being not applied, when the current block is coded with the CIIP mode; and
processing the target block with the CIIP mode and a luma mapping with chroma scaling (LMCS).

38. An apparatus for performing video data processing, the apparatus comprising:

a memory figured to store instructions; and

one or more processors configured to execute the instructions to cause the apparatus to perform:
receiving a bitstream associated with a target block;
determining whether a luma mapping with chroma scaling (LMCS) is enabled for the target block;
in response to the LMCS being enabled, determining that a combined inter and intra prediction (CIIP) mode is not applied; and
processing the target block with the LMCS and an overlapped block motion compensation (OBMC) mode.

39. An apparatus for performing video data processing, the apparatus comprising:

a memory figured to store instructions; and

one or more processors configured to execute the instructions to cause the apparatus to perform:
determining a combined inter and intra prediction (CIIP) mode being enabled for a target block;
determining an inter predictor with a motion vector, wherein the motion vector is obtained using a motion vector predictor and a signaled motion vector difference;
determining an intra predictor; and
obtaining a final predictor of the target block by weighting the inter predictor and the intra predictor.

40. The apparatus according to clause 39, wherein the target block is coded with a regular inter mode and not coded with a merge mode.

41. The apparatus according to clause 40, wherein inter modes except the regular inter mode are disabled.

42. The apparatus according to clause 41, wherein the inter modes comprises one or more of a local illumination compensation mode, a bi-prediction with coding unit-level weight mode, an affine mode, a symmetric motion vector difference mode, an adaptive motion vector resolution mode, or a multi-hypothesis inter prediction mode.

43. The apparatus according to any one of clauses 40 to 42, wherein the one or more processors are further configured to execute the instructions to cause the apparatus to perform:

determining the CIIP mode being enabled for the target block based on a flag.

44. The apparatus according to clause 43, wherein the flag is decoded at a beginning of a regular inter mode syntax structure.

45. The apparatus according to clause 44, wherein the flag is decoded at an end of a regular inter mode syntax structure.

46. The apparatus according to any one of clauses 39 to 45, wherein the inter predictor is generated using a merge mode with motion vector difference (MMVD) method.

47. The apparatus according to any one of clauses 39 to 46, wherein the intra predictor is generated using a template-based intra mode derivation (TIMD) method or a decoder-side intra mode derivation (DIMD) method.

In some embodiments, a non-transitory computer-readable storage medium including instructions is also provided. In some embodiments, the medium can store all or portions of the video bitstream having one or more flags that indicates prediction modes applied, such as the modes applied with respect to FIG. 14 to FIG. 19. In some embodiments, the medium can store instructions that may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

1. A method for video processing, wherein a combined inter and intra prediction (CIIP) and luma mapping with chroma scaling (LMCS) are applied, the method comprises:
obtaining an inter prediction signal, an intra prediction signal, and an overlapped block motion compensation (OBMC) prediction signal;
obtaining an intermediate weighted prediction signal by weighting the inter prediction signal and a first prediction signal of the intra prediction signal and the OBMC prediction signal; and
obtaining a final prediction signal by weighting the intermediate weighted prediction signal and a second prediction signal of intra prediction signal and the OBMC prediction signal;
wherein the intermediate weighted prediction signal and the second prediction signal are both in one of a mapped domain or an original domain.

2. The method according to claim 1, wherein obtaining the inter prediction signal, the intra prediction signal, and the OBMC prediction signal further comprises:
obtaining the inter prediction signal in an original domain;
obtaining the intra prediction signal in a mapped domain; and
obtaining the OBMC prediction signal in the original domain.

3. The method according to claim 2, wherein obtaining the intermediate weighted prediction signal by weighting the inter prediction signal and the first prediction signal of the intra prediction signal and the OBMC prediction signal comprises:
converting the inter prediction signal from the original domain to the mapped domain; and
obtaining the intermediate weighted prediction signal by weighting the converted inter prediction signal and the intra prediction signal in the mapped domain; and
wherein obtaining the final prediction signal by weighting the intermediate weighted prediction signal and the second prediction signal of intra prediction signal and the OBMC prediction signal further comprises:
converting the OBMC prediction signal from the original domain to the mapped domain; and
obtaining the final prediction signal by weighting the intermediate weighted prediction signal and the OBMC prediction signal in the mapped domain.

4. The method according to claim 2, wherein obtaining the intermediate weighted prediction signal by weighting the inter prediction signal and the first prediction signal of the intra prediction signal and the OBMC prediction signal comprises:
converting the inter prediction signal from the original domain to the mapped domain; and
obtaining the intermediate weighted prediction signal by weighting the converted inter prediction signal and the intra prediction signal in the mapped domain; and
wherein obtaining the final prediction signal by weighting the intermediate weighted prediction signal and the second prediction signal of intra prediction signal and the OBMC prediction signal further comprises:
converting the intermediate weighted prediction signal from the mapped domain to the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

5. The method according to claim 2, wherein obtaining the intermediate weighted prediction signal by weighting the inter prediction signal and a first prediction signal of the intra prediction signal and the OBMC prediction signal comprises:
converting the intra prediction signal from the mapped domain to the original domain; and
obtaining the intermediate weighted prediction signal by weighting the inter prediction signal and the converted intra prediction signal in the original domain; and
wherein obtaining the final prediction signal by weighting the intermediate weighted prediction signal and the second prediction signal of intra prediction signal and the OBMC prediction signal further comprises:
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

6. The method according to claim 2, wherein obtaining the intermediate weighted prediction signal by weighting the inter prediction signal and a first prediction signal of the intra prediction signal and the OBMC prediction signal comprises:
obtaining the intermediate weighted prediction signal by weighting the inter prediction signal and the OBMC prediction signal in the original domain; and
wherein obtaining the final prediction signal by weighting the intermediate weighted prediction signal and the second prediction signal of intra prediction signal and the OBMC prediction signal further comprises:
converting the intermediate weighted prediction signal from the original domain to the mapped domain; and
obtaining the final prediction signal by weighting the converted intermediate weighted prediction signal and the intra prediction signal in the mapped domain.

7. The method according to claim 1, wherein the inter prediction signal is obtained using an inter prediction process applied to a regular merge mode.

8. The method according to claim 1, wherein the OBMC prediction signal is obtained using a motion from neighboring blocks.

9. An apparatus for performing video data processing, wherein a combined inter and intra prediction (CIIP) and luma mapping with chroma scaling (LMCS) are applied, the apparatus comprising:
a memory figured to store instructions; and
one or more processors configured to execute the instructions to cause the apparatus to perform:
obtaining an inter prediction signal, an intra prediction signal, and an overlapped block motion compensation (OBMC) prediction signal;
obtaining an intermediate weighted prediction signal by weighting the inter prediction signal and a first prediction signal of the intra prediction signal and the OBMC prediction signal; and
obtaining a final prediction signal by weighting the intermediate weighted prediction signal and a second prediction signal of intra prediction signal and the OBMC prediction signal;
wherein the intermediate weighted prediction signal and the second prediction signal are both in one of a mapped domain or an original domain.

10. The apparatus according to claim 9, wherein the one or more processors are further configured to execute the instructions to cause the apparatus to perform:
obtaining the inter prediction signal in an original domain;
obtaining the intra prediction signal in a mapped domain; and
obtaining the OBMC prediction signal in the original domain.

11. The apparatus according to claim 10, wherein the one or more processors are further configured to execute the instructions to cause the apparatus to perform:
converting the inter prediction signal from the original domain to the mapped domain;
obtaining the intermediate weighted prediction signal by weighting the converted inter prediction signal and the intra prediction signal in the mapped domain;
converting the OBMC prediction signal from the original domain to the mapped domain; and
obtaining the final prediction signal by weighting the intermediate weighted prediction signal and the OBMC prediction signal in the mapped domain.

12. The apparatus according to claim 10, wherein the one or more processors are further configured to execute the instructions to cause the apparatus to perform:
converting the inter prediction signal from the original domain to the mapped domain; and
obtaining the intermediate weighted prediction signal by weighting the converted inter prediction signal and the intra prediction signal in the mapped domain;
converting the intermediate weighted prediction signal from the mapped domain to the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

13. The apparatus according to claim 10, wherein the one or more processors are further configured to execute the instructions to cause the apparatus to perform:
converting the intra prediction signal from the mapped domain to the original domain;
obtaining the intermediate weighted prediction signal by weighting the inter prediction signal and the converted intra prediction signal in the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

14. The apparatus according to claim 10, wherein the one or more processors are further configured to execute the instructions to cause the apparatus to perform:
obtaining the intermediate weighted prediction signal by weighting the inter prediction signal and the OBMC prediction signal in the original domain;
converting the intermediate weighted prediction signal from the original domain to the mapped domain; and
obtaining the final prediction signal by weighting the converted intermediate weighted prediction signal and the intra prediction signal in the mapped domain.

15. The apparatus according to claim 9, wherein the inter prediction signal is obtained using an inter prediction process applied to a regular merge mode.

16. The apparatus according to claim 9, wherein the OBMC prediction signal is obtained using a motion from neighboring blocks.

17. A non-transitory computer readable storage medium storing a bitstream of a video for processing according to a method, wherein a combined inter and intra prediction (CIIP) and luma mapping with chroma scaling (LMCS) are applied on the video, and the method comprises:
obtaining an inter prediction signal, an intra prediction signal, and an overlapped block motion compensation (OBMC) prediction signal;
obtaining an intermediate weighted prediction signal by weighting the inter prediction signal and a first prediction signal of the intra prediction signal and the OBMC prediction signal; and
obtaining a final prediction signal by weighting the intermediate weighted prediction signal and a second prediction signal of intra prediction signal and the OBMC prediction signal;
wherein the intermediate weighted prediction signal and the second prediction signal are both in one of a mapped domain or an original domain.

18. The non-transitory computer readable storage medium according to claim 17, wherein obtaining the inter prediction signal, the intra prediction signal, and the OBMC prediction signal further comprises:
obtaining the inter prediction signal in an original domain;
obtaining the intra prediction signal in a mapped domain; and
obtaining the OBMC prediction signal in the original domain.

19. The non-transitory computer readable storage medium according to claim 18, wherein obtaining the intermediate weighted prediction signal by weighting the inter prediction signal and the first prediction signal of the intra prediction signal and the OBMC prediction signal comprises:
converting the inter prediction signal from the original domain to the mapped domain; and
obtaining the intermediate weighted prediction signal by weighting the converted inter prediction signal and the intra prediction signal in the mapped domain; and
wherein obtaining the final prediction signal by weighting the intermediate weighted prediction signal and the second prediction signal of intra prediction signal and the OBMC prediction signal further comprises:
converting the intermediate weighted prediction signal from the mapped domain to the original domain;
obtaining an intermediate final prediction signal by weighting the intermediate weighted prediction signal and the OBMC prediction signal in the original domain; and
obtaining the final prediction signal by converting the intermediate final prediction signal from the original domain to the mapped domain.

20. The non-transitory computer readable storage medium according to claim 18, wherein obtaining the intermediate weighted prediction signal by weighting the inter prediction signal and a first prediction signal of the intra prediction signal and the OBMC prediction signal comprises:
obtaining the intermediate weighted prediction signal by weighting the inter prediction signal and the OBMC prediction signal in the original domain; and
wherein obtaining the final prediction signal by weighting the intermediate weighted prediction signal and the second prediction signal of intra prediction signal and the OBMC prediction signal further comprises:
converting the intermediate weighted prediction signal from the original domain to the mapped domain; and
obtaining the final prediction signal by weighting the converted intermediate weighted prediction signal and the intra prediction signal in the mapped domain.
